(19) United States
(12) Patent Application Publication
(10) Pub. No.: US 2003/0161036 A1
(43) Pub. Date: Aug. 28, 2003

(54) Motorised microscope

(76) Inventor: Matthias Gonschor, Gleichen (DE)

Correspondence Address: REED SMITH, LLP, ATTN: PATENT RECORDS DEPARTMENT, 599 LEXINGTON AVENUE, 29TH FLOOR, NEW YORK, NY, 10022-7650, US

(21) Appl. No.: 10/169,227

(22) PCT Filed: Oct. 2, 2001
(86) PCT No.: PCT/EP01/11382

(30) Foreign Application Priority Data
Oct. 13, 2000 (DE) 100 51 301.8

(51) Int. Cl. G02B 21/00

(52) U.S. Cl. 359/368; 359/382; 359/389

(57) ABSTRACT

The invention is directed to a motorized microscope with a plurality of electrically controlled microscope components such as objective nosepiece, filter turret, diaphragms, light path switching arrangements, illumination device, etc. which influence the light path in the microscope. In order to make an image from any situation visible quickly in the eyepieces, it is provided that an operator control, when actuated, moves all of these components into a position such that the light path from the illumination device to the eyepieces is opened.

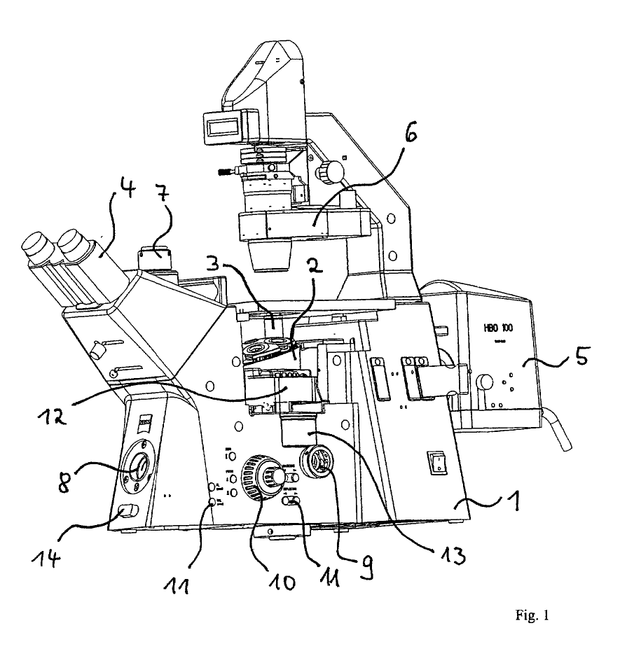

The invention is directed to a motorized microscope, particularly a research microscope, which can be outfitted with a plurality of electrically controllable components such as objective nosepiece, diverse filters and diaphragms, adjustable illumination devices, and light path switching arrangements for photographic outputs (interfaces) for external image capture systems.

In modern microscopes, the plurality of photographic outputs are provided in order to enhance universality so that it is possible, e.g., to switch rapidly between wet photography and modem digital photography. The light paths can be switched to the individual photographic outputs electrically by actuating keys or buttons on the microscope or on an external control device. Further, other microscope components which influence the light path from the illumination device to the eyepiece, such as adjustable or switchable illumination, reflector turrets and diverse diaphragms, are also often electrically controllable.

The adjustment of a certain condition or state is a complex process and it may come about that the user no longer sees an image in the eyepieces or at the desired photographic output as the result of fine adjustments. The reason for this may be, for example, that a diaphragm in front of the illumination device has been closed or that all of the light has been directed to a different photographic output than the intended one. In this case, the only remaining possibility is often to correct the fine adjustment by systematic trial and error, which can be a relatively cumbersome process due to the complexity and possible mutual influencing of the components.

Therefore, it is the object of the invention to overcome the disadvantages of the prior art and to simplify the operation of electrically controllable or motorized microscopes.

This object is met in a motorized microscope according to the preamble of the first claim by the characterizing features of claim 1.

In an advantageous embodiment form according to the invention, this defined position of the microscope components is characterized in that the respective component opens the light path associated with it from the illumination device to the viewing eyepieces in accordance with its possibility.

Alternatively, it can be advantageous that this defined position releases the light path to one of the photographic outputs. The operator control can be arranged on the microscope stand or on a control device which is electrically connected with the microscope.

In a method, according to the invention, for controlling a motorized microscope, an operator control of the microscope is given a function for opening the light path from the illumination device to the eyepieces or to one of the photographic outputs.

The drawing shows an embodiment example of a microscope according to the invention.

A motor-actuated objective nosepiece (2) with objective (only one objective in this case) (3), an eyepiece (4), a motor-actuated reflector turret (12), an adjustable illumination device (5) and a motor-actuated condenser (6) are arranged on the microscope stand (1). The stand has a plurality of photographic outputs (7, 8, 9) whose light paths can be switched by means of motor-actuated light path switching devices (mirrors, prisms), not shown in the drawing. Further, the stand has a focusing drive knob (10) and a quantity of control buttons (11) which are arranged in an ergonomic manner in the vicinity of the focusing drive knob. The focusing drive (13) is motor-actuated by means of the focusing drive knob (10) through a control computer (not shown) which is installed in the microscope stand (1). A determined control button (14), when actuated, causes an opening of the light path from the illumination device (5) to the eyepieces (4), for example. In a manner, known per se, the microscope control computer has an arithmetic unit, an EPROM which contains the program for controlling the microscope and its components, and a RAM in which variable data for the control program are kept. The components are moved or switched by motor in a defined manner by means of this control computer according to presets stored in the program. Depending on the type of component, discrete positions or quasi-continuous positions can be implemented. A position value is stored in the EPROM for every component, this position value being characterized in that, in this position, the component releases the light path to the extent that this is possible for the component.

Such an open condition of the microscope can consist of the following, for example:

1. The illumination device is switched on.

2. The field diaphragm and aperture diaphragm are fully opened.

3. Any existing shutters are opened.

4. The condenser turret is moved to the brightfield position.

5. All light path switches (mirrors, prisms) are switched in such way that the light path from the illumination device to the eyepieces is open.

The invention is not limited to the embodiment example shown herein. In order to be able to make use of the invention for the transmitted light beam path as well as for the incident light beam path, it is also possible to store the open positions assigned to the respective beam path for the corresponding component and to move to the corresponding position, depending on the type of illumination, when the button (14) is actuated.

Further, the invention can be applied in upright microscopes as well as in inverted microscopes.

1. Motorized microscope comprising a microscope stand which contains electrically controllable microscope components which influence the light path between an illumination device and viewing eyepieces, e.g., objective nosepiece, light source, light path switches, particularly for photographic outputs, condensers and diaphragms which are controlled electrically by a control unit, and in which operator controls are provided for these electrical control adjustments, characterized in that there is at least one operator control which is switched by the control adjustments in such a way that the actuation of this operator control moves each of these components into a defined position.

2. Motorized microscope according to claim 1, characterized in that this defined position is characterized in that the respective component opens the light path associated with it from the illumination device to the viewing eyepieces in accordance with its possibility.

3. Motorized microscope according to claim 1, characterized in that this defined position is characterized in that the respective component opens the light path associated with it from the illumination device to a photographic output in accordance with its possibility.

4. Motorized microscope according to one of claims 1 to 3, characterized in that the operator control is provided at the microscope stand.

5. Motorized microscope according to one of claims 1 to 3, characterized in that the operator control is provided at a control device which is electrically connected to the microscope stand.

6. Method for controlling a motorized microscope, preferably according to one of the preceding claims, characterized in that an operator control of the microscope is given a function for opening the light path from the illumination device to the viewing eyepieces.

7. Method for controlling a motorized microscope, preferably according to one of the preceding claims, characterized in that an operator control of the microscope is given a function for opening the light path from the illumination device to a photographic output.
